(19) United States
(12) Patent Application Publication
(10) Pub. No.: US 2009/0102247 A1
(43) Pub. Date: Apr. 23, 2009

(54) SLATTED ROOF FOR A MOTOR VEHICLE

(75) Inventors: Ulrich Grosser, Kuerten (DE); Roland Brambrink, Ratingen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/254,436

(22) Filed: Oct. 20, 2008

(30) Foreign Application Priority Data
Oct. 19, 2007 (DE) 102007050459.6

(51) Int. Cl. B60J 7/04; B60J 7/047; B29C 45/00

(52) U.S. Cl. 296/220.01; 296/216.04; 264/297.2

(57) ABSTRACT

A vehicle roof having a folding arrangement and a device for receiving the folding arrangement. The folding arrangement has a plurality of slats which are arranged parallel to one another, wherein adjacent slats are coupled along respective longitudinal sides by an elastomer. The folding arrangement is moveable between a closed position, in which the slats block an opening in the roof and an open position, in which the slats are retracted and folded together into the device.

### BACKGROUND OF THE INVENTION

1. Priority

Priority is claimed to German Patent Application No. 102007050459.6, filed Oct. 19, 2007. The disclosure of the aforementioned priority application is incorporated herein by reference in its entirety.

2. Field of the Invention

The field of the present invention relates to slatted roofs for motor vehicles.

3. Background

There are a number of types of sliding roofs for vehicles including, rigid, one-piece, transparent and non-transparent sliding roofs. Slatted roofs made of transparent materials are also manufactured. These are described, inter alia, in German Patent No. DE 4415649 C1 and European Patent No. EP91644 A2. European Patent No. EP1125778 A2 describes a vehicle roof which is capable of opening and has at least two roof systems which are arranged one behind the other and are capable of opening separately, and of which a front roof system comprises at least one lid which can be swung out with its rear edge over the fixed vehicle roof.

When a slatted roof is opened, the combination of individual slats is broken up, which necessitates incorporating an additional, separable sealing area between the individual slats. A slatted roof also requires complex kinematics (for example German Patent No. DE 19959542 A1) and high stiffness of the components of the individual slats in order to maintain the sealing force over the life span. The structure for absorbing the sealing forces reduces the transparent see-through area considerably (by up to 50%) and requires a great deal of installation space. These limitations impair the freedom of design and, in particular, the aerodynamics. Furthermore, the slatted roofs described may only be moved in the longitudinal axis of the vehicle. Alternative configurations which move in the transverse axis of the vehicle are prohibited by limited installation space and severe wind noise, which may occur due to the slats (or components) protruding from the contour of the vehicle. Window blinds made of glass, which are connected in a material-bonded manner, are also known (German Patent No. DE 29607921). Glass slats of this kind have very high stiffness with, at the same time, high weight and low impact strength.

### SUMMARY OF THE INVENTION

The present invention is directed toward a slatted roof for a motor vehicle. The slatted roof has a folding arrangement with a plurality of plastic slats which are arranged parallel to one another. Adjacent slats are coupled by an elastomer along respective longitudinal sides. The roof also contains a device for receiving the folding arrangement. The folding arrangement is thus moveable between a closed position, in which the slats block an opening in the roof, and an open position, in which the slats are retracted and folded together into the device.

In a first separate aspect of the present invention, the longitudinal sides of the slats align with a longitudinal direction of the roof

In a second separate aspect of the present invention, the folding arrangement has 3, 4, 5, or 6 slats oriented longitudinally with the direction of the roof.

In a third separate aspect of the present invention, the folding arrangement has 7, 8, 9, 10, 11, or 12 slats oriented transversely with the direction of the roof.

In a fourth separate aspect of the present invention, the folding arrangement may be manufactured using a two-component injection-molding process.

In a fifth separate aspect of the present invention, any of the foregoing separate aspects may be employed in combination.

Accordingly, an improved slatted roof for a motor vehicle is disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1 illustrates a perspective isometric view of a sliding roof;

FIG. 2 illustrates a right side view of the roof of FIG. 1;

FIG. 3 illustrates a top view of the roof of FIG. 1;

FIG. 4 illustrates a front side view of the roof of FIG. 1;

FIG. 5 illustrates a rear side view of the roof of FIG. 1;

FIG. 6 illustrates a detailed rear side view of a flashing direction-indicator of FIG. 5;

FIG. 7 illustrates a perspective view of a partial folding arrangement;

FIG. 7a illustrates a side view of the partial folding arrangement of FIG. 7 with an elastomer hinge without a cut-out;

FIG. 7b illustrates a side view of the partial folding arrangement of FIG. 7 with an elastomer hinge with a cut-out;

FIG. 7c illustrates a side view of the partial folding arrangement of FIG. 7 with an elastomer hinge with an omega-shaped cut-out;

FIG. 8 illustrates a perspective view of the open, or partially open, roof of FIG. 1;

FIG. 9 illustrates a perspective view of a folding arrangement;

FIG. 9a illustrates a sectional view of guide rails and a partial folding arrangement;

FIG. 9b illustrates a perspective view of the guide rails and the partial folding arrangement of FIG. 9a; and

FIG. 9c illustrates a detailed perspective view of the guide rails and the partial folding arrangement of FIG. 9b.

### DETAILED DESCRIPTION OF THE PREFERRED EMBODIMENTS

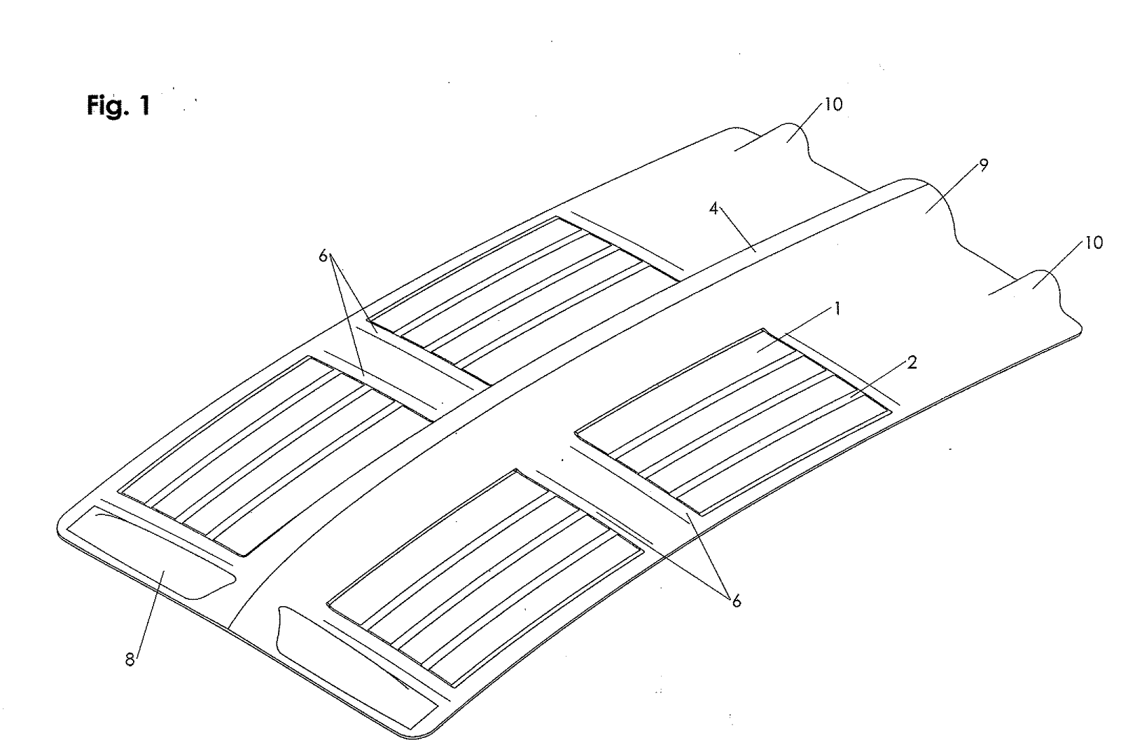

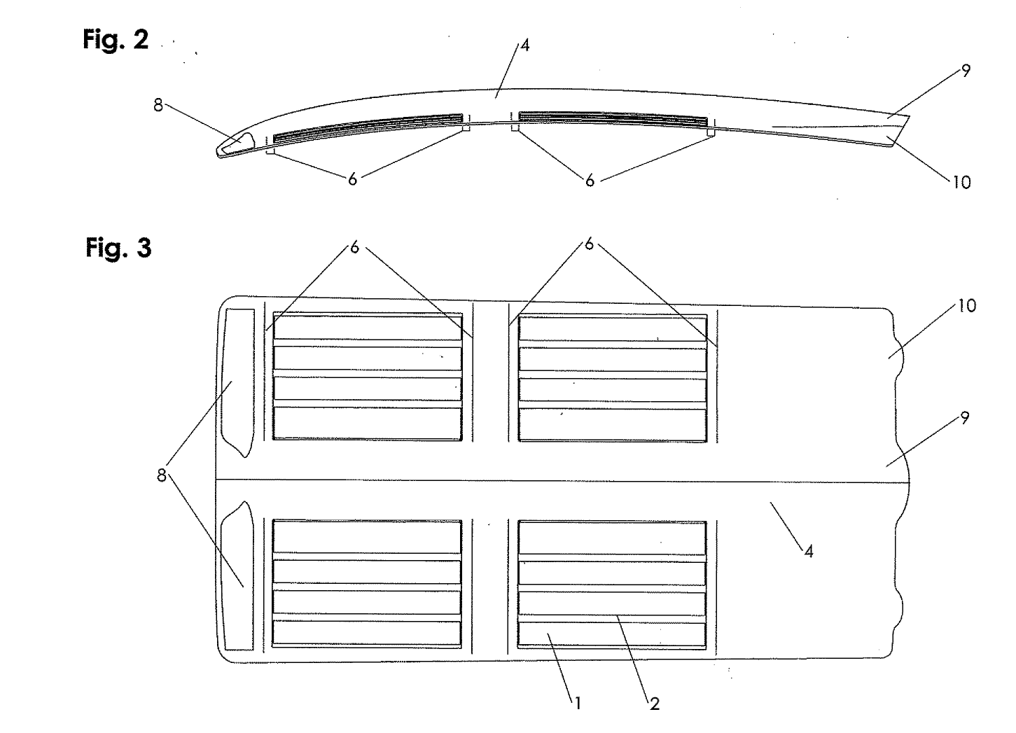

Turning to the drawings, FIG. 1 illustrates a vehicle roof having four folding arrangements and one device [4] for receiving the latter. The folding arrangements have four slats [1] made of plastic which are arranged parallel to one another. The slats are connected by elastomer [2] over the predominant part of their longitudinal sides. The folding arrangement can be retracted and folded into the device [4] which is provided for it, in order to at least partially unblock the opening [3], as shown in FIG. 8. The folding arrangement closes the opening [3] completely when in the closed position, as is also shown in FIG. 8.

The slats [1] consist of a plastic such as a transparent thermoplastic, for example polycarbonate (PC), polymethyl methacrylate (PMMA, acrylic glass or Plexiglas). The slats are connected to one another in a material-bonded and/or form-closed manner by means of elastomer [2], for example polyurethane, thermoplastic polyurethane or a silicone.

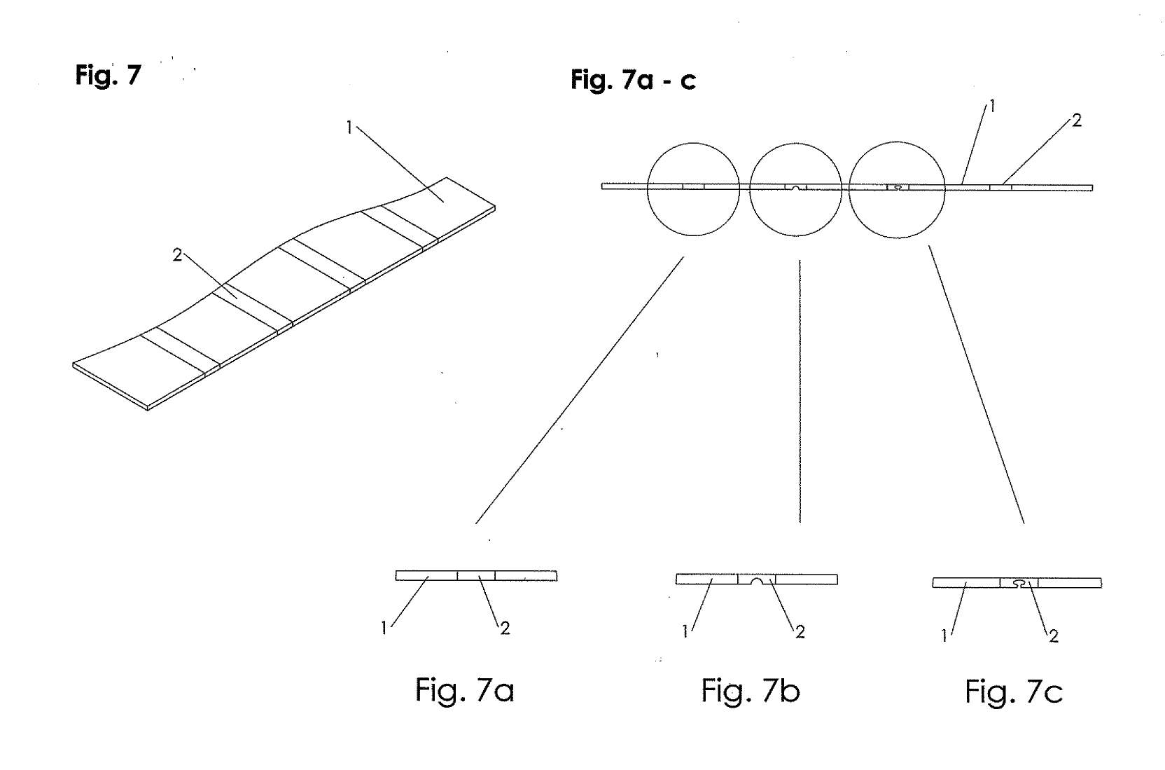

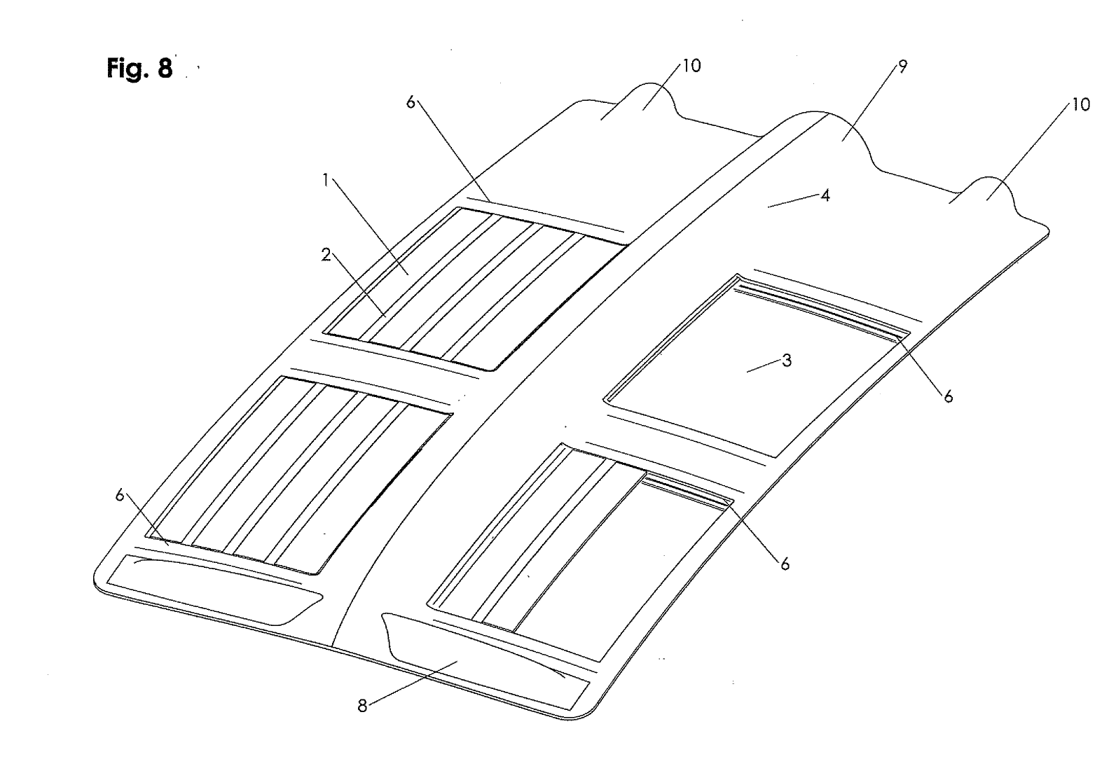

The structure consisting of the slats [1] and elastomer [2] is referred to as the “folding arrangement.” The elastomer [2] serves as a hinge and can be designed with suitable geometries (FIGS. 7a to 7c). Because of the materially-bonded connection, a complicated, highly stressed substructure or additional sealing plane is no longer necessary, thereby reducing the installation space required when the roof is folded, and increasing the reliability of the roof due to fewer individual parts.

Both the thermoplastic slats and the elastomer are ideally transparent or translucent. Both of them may, for example, be the same color as a vehicle having the slatted roof, or even be illuminated by means of illuminants, for example LED's. Furthermore, the slats may contain UV-absorbers or IR-absorbers and thus regulate the incidence of UV or IR into the interior of the vehicle, or may have a scratch-resistant layer.

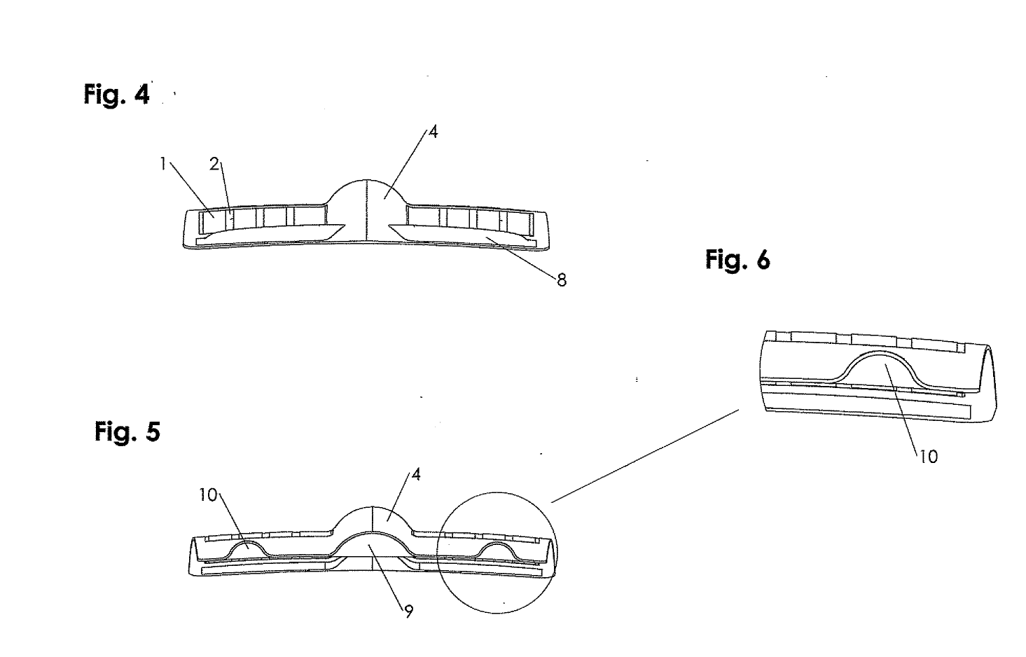

As shown in FIG. 8, to open the roof [3], the folding arrangement is accommodated in a device, for example a hood box [4] or boot lid, which is provided for it, as further illustrated in FIGS. 4 to 6. Something of that kind is known, for example, from DE 10207729. Here, the folding arrangement may be folded up/rolled up into the hood [4]. The hood [4] is described by an installation space, and may therefore be open or a case. In the open state, therefore, the slats may be located in a concealed or an open manner.

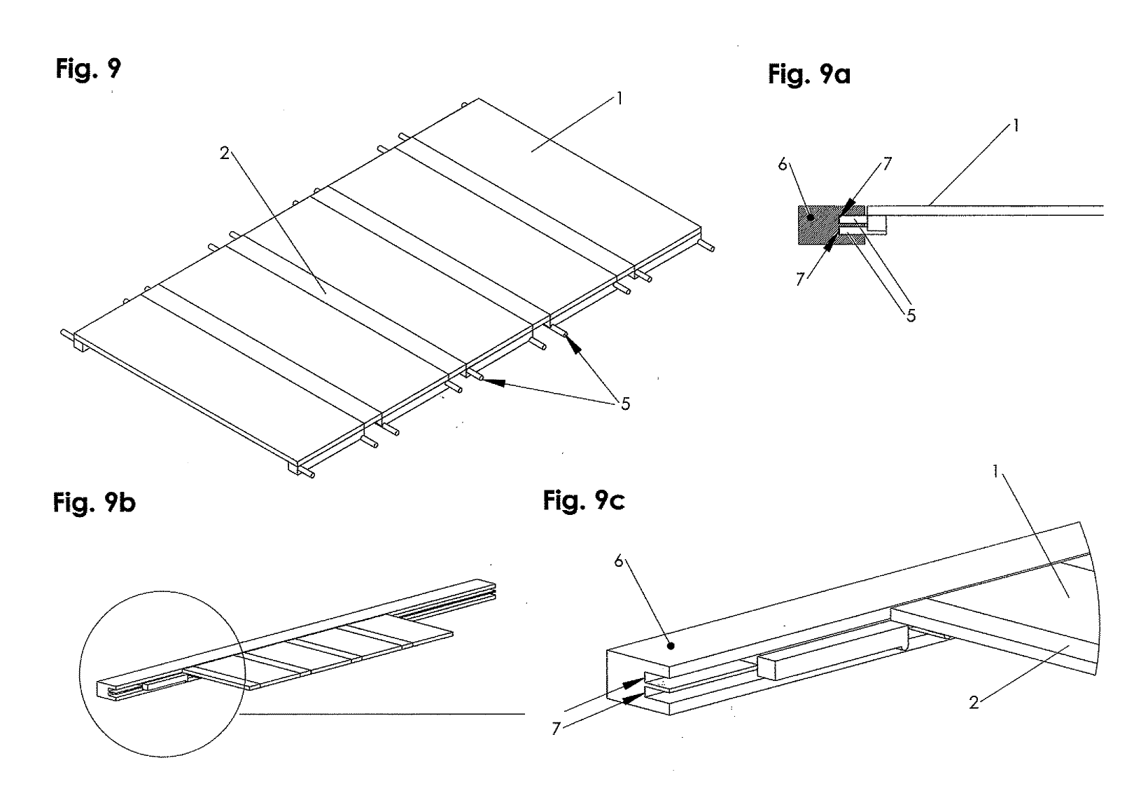

As shown in FIGS. 9 to 9c, to move the folding arrangement, pins [5] which are guided in guide rails [6] may be attached to the end of the slats. Under these circumstances, the guide rails [6] may also serve, at the same time, as gutters. The guide rails are formed by way of at least one groove [7]. As further shown in FIG. 8, for the most part, the groove extends parallel to the lip of the roof skin, so that the slats move over the largest part of the roof, even in the half-open state, in a manner plane parallel to the roof skin. Only in the region of the folding operation does the groove no longer extend in a parallel manner, with the result that the ends of the slats can be rolled up after the fashion of a concertina or roller blind.

Since the slats extend, even in the half-open state, almost parallel to the roof skin, they are capable of lying both longitudinally and transversely and at any other desired angle in relation to the direction of travel, with the longitudinal direction being in the direction of travel of the vehicle, without severe wind noise or negative aerodynamic effects occurring under these circumstances.

The folding arrangement may be manufactured in an injection-molding process from a suitable thermoplastic, ideally polycarbonate, or even from deep-drawn sheet metal.

The folding arrangement may be manufactured, for example, by two-component injection-molding technology, in which the slats are injected in the first step and the elastomer, such as TPU, is injected between said slats in the second step.

Another possibility lies in the technology described in German Patent No. DE 19650854. Here too, the slats would be injected in the first step in the injection-molding process and a reactive mixture, which reacts to a thermosetting plastic, would be injected in the second step instead of the thermosetting plastic used here, however, an elastomer would be used. In this case, the slats would likewise be injection-molded in a first step, and a reactive mixture would be poured into the cavity in a second step. This reactive mixture may consist of the basic substances for a polyurethane, or of other reactive materials.

As shown in FIG. 1, if the vehicle roof is manufactured from a thermoplastic such as polycarbonate, it is possible to incorporate still other functions such as, for example, wind-deflectors [8] or projecting rear lights [9] or flashing direction-indicators [10].

Thus, a slatted vehicle roof is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A vehicle roof comprising:
a folding arrangement having a plurality of slats arranged parallel to one another, wherein adjacent slats are coupled along respective longitudinal sides of the slats by an elastomer; and
a device for receiving the folding arrangement, the folding arrangement being moveable between a closed position, in which the slats block an opening in the roof, and an open position, in which the slats are retracted and folded together into the device.

2. The vehicle roof of claim 1, wherein the longitudinal sides of the slats align with a longitudinal direction of the roof.

3. The vehicle roof of claim 1, wherein the slats comprise a thermoplastic.

4. The vehicle roof of claim 3r wherein the thermoplastic is one of polycarbonate or PMMA.

5. The vehicle roof of claim 3, wherein the thermoplastic has one or more UV-absorbing, IR-absorbing or scratch-resistant layers.

6. The vehicle roof of claim 1, wherein the elastomer is one of a polyurethane, a thermoplastic polyurethane, or a silicone.

7. The vehicle roof of claim 1, wherein the plurality of slats further comprises 3, 4, 5, or 6 slats, the longitudinal sides of the slats being aligned with a longitudinal direction of the roof.

8. The vehicle roof of claim 1, wherein the plurality of slats further comprises 7, 8, 9, 10, 11, or 12 slats, the longitudinal sides of the slats being aligned with a transverse direction of the roof.

9. A vehicle roof comprising:
a plurality of folding arrangements, each having a plurality of slats arranged parallel to one another, wherein adjacent slats are coupled along respective longitudinal sides of the slats by an elastomer; and
at least one device for receiving the folding arrangements, each folding arrangement being moveable between a closed position, in which the slats block an opening in the roof, and an open position, in which the slats are retracted and folded together into the device.

10. The vehicle roof of claim 9, wherein the longitudinal sides of the slats align with a longitudinal direction of the roof.

11. The vehicle roof of claim 9, wherein the slats comprise a thermoplastic.

12. The vehicle roof of claim 11, wherein the thermoplastic is one of polycarbonate or PMMA.

13. The vehicle roof of claim 1 1, wherein the thermoplastic has one or more UV-absorbing, IR-absorbing or scratch-resistant layers.

14. The vehicle roof of claim 9, wherein the elastomer is one of a polyurethane, a thermoplastic polyurethane, or a silicone.

15. The vehicle roof of claim 9, wherein the plurality of slats of at least two folding arrangements further comprises 3, 4, 5, or 6 slats, the longitudinal sides of the slats being aligned with a longitudinal direction of the roof.

16. The vehicle roof of claim 9, wherein the plurality of slats of at least two folding arrangements further comprises 7, 8, 9, 10, 11, or 12 slats, the longitudinal sides of the slats being aligned with a transverse direction of the roof.

17. A method of manufacturing a vehicle roof having a folding arrangement and a device for receiving the folding arrangement, wherein the folding arrangement has a plurality of slats arranged parallel to one another, wherein adjacent slats are coupled along respective longitudinal sides by an elastomer and wherein the folding arrangement is moveable between a closed position, in which the slats block an opening in the roof, and an open position, in which the slats are retracted and folded together into the device, the method comprising molding the folding arrangement using a two-component injection-molding process.

18. The method according to claim 17, the two-component injection-molding process further comprising injection-molding the slats and injection-molding the elastomer.

19. The method according to claim 17 further comprising:
extruding the slats;
cutting the extruded slats;
laying the extruded slats in an injection-molding tool; and
injecting the elastomer between the extruded slats.
